(19) United States
(12) Patent Application Publication
(10) Pub. No.: US 2004/0062516 A1
(43) Pub. Date: Apr. 1, 2004

(54) Moving picture experts group phase 2 transport stream data editing method

(75) Inventors: Eishi Takeda, Tokyo (JP); Hideta Nishizawa, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/657,222

(22) Filed: Sep. 9, 2003

(30) Foreign Application Priority Data
Sep. 17, 2002 (JP) 2002-270131
Apr. 10, 2003 (JP) 2003-106578

(51) Int. Cl. G11B 27/00

(52) U.S. Cl. 386/4; 375/240.26; 375/240.08

(57) ABSTRACT

Disclosed is a data editing method for editing MPEG-2 transport stream data recorded on a disk form recording medium having a plurality of sectors, the data editing method including: detecting a common boundary position which is located before one of a divide position and a combine position in data, and meets a packet boundary and a sector boundary; and performing one of a dividing process and a combining process for the data at the common boundary position as a reference. With this arrangement, head seek time up to a reproduction access start position can be shortened.

### BACKGROUND OF THE INVENTION

1. Field of the Invention

The present invention relates to a data editing method in a case of dividing/combining a data file in a disk recording and reproducing device, which records or reproduces MPEG2 transport stream data based on the Moving Picture Experts Group (hereinafter, referred to as “MPEG”) standard.

2. Related Background Art

Nowadays, in satellite digital broadcasting and terrestrial digital broadcasting in Japan, Europe, and America, for a data format for transmitting image and audio signals, MPEG2 transport stream (hereinafter, referred to as “MPEG-2 TS”) defined by IEC/ISO 13818 is being used.

MPEG-2 TS is time-division multiplexed in units referred to as MPEG-2 TS packets, having a fixed length of 188 bytes and carrying information data corresponding to images and audio of a broadcast program.

If, on the receiving side, the MPEG-2 TS corresponding to the broadcast program can be saved as a written record or data file onto, for example, a random access disk form recording medium such as a hard disk or an optical disk in the same information-compressed digital signal state as the sending side, then a high quality audio/visual program can be repeatedly viewed/listened to without damaging the image quality or the sound quality at all when necessary, and highly responsive random access reproduction and program editing with a high degree of flexibility would be possible.

Next, description is made of a conventional example employing the above-mentioned technique. FIG. 1 shows a data structure of the MPEG-2 TS recorded onto the disk form recording medium. FIG. 2 is a diagram showing file system information for managing a data file on the disk. FIGS. 3A through 6C are explanatory diagrams for explaining processing methods when performing a dividing/editing process for data.

First, in a case where the MPEG-2 TS data is written onto the disk as shown in FIG. 1, it is recorded consecutively into logical blocks called sectors, or, in a case of insufficient consecutive unrecorded sectors, it is recorded non-consecutively on the disk. Letters A, B1, B2, C1 and C2 of FIG. 2 refer to data recorded on the disk. Note that, in this specification, the size of 1 sector is assumed to be 2048 bytes.

Up to now, as specifications for file systems such as a File Allocation Table (hereinafter, referred to as “FAT”) and a Universal Disk Format (hereinafter, referred to as “UDF”) which are used as formats for managing the data files on the random access disk form recording medium such as a hard disk or an optical disk, the following three rules have been determined.

(1) The position where the data is written must start at the beginning of a sector.

(2) The data cannot stop midway through a sector other than in the sector where the end of the data file is present.

(3) There cannot be sector areas where different data files overlap.

The specifications defined by these rules must be followed even at the time of writing and an editing process for the MPEG-2 TS data.

According to the above-mentioned procedure, the MPEG-2 TS data recorded on the disk is managed as a file. In order to facilitate the editing process later on, as a method of building a user interface, a table is used for linking a file name and information showing the file's position on the disk, including: a file name of the MPEG-2 TS data being managed as shown in FIG. 2 (the file name can be freely defined by the user); a start sector number showing where the data file starts to be recorded; and a data size of an area starting from the start sector. This method enables the user to access desired data without being aware of which data is present at which position on the disk, simply by designating the file name.

Next, description is made of a dividing process performed on the MPEG-2 TS data file having the data structure shown in FIG. 1 and the file system information with reference to FIGS. 3A through 6C and a flowchart of FIG. 7. Step numbers of FIGS. 3A through 6C correspond to those of FIG. 7.

First, a user issues a request to divide the MPEG-2 TS data recorded on the disk, a file name FILE0000, an access start sector position #N, and an access data size 188×n₁, at a position 188×n_{div} bytes shown in FIG. 1, which is the boundary of the TS packet, to set the area from the start of the MPEG-2 TS data to the divide position as a FILE0001, and to set the area from the divide position to the MPEG-2 TS data end as a FILE0002 (step 1 of FIG. 7, FIG. 3A).

In response to this request, the data from the start of the file to the divide position is registered in the file system information as the new file name FILE0001, access start sector position #N and access data size 188×n_{div} (step 2 of FIG. 10, FIG. 6B).

Here, similarly to step 2, the data from the divide position 188×n_{div}-bytes to the MPEG-2 TS data end position 188×n₁ is set as FILE0002, with access start sector position at 188×n_{div} bytes and access data size of (188n₁-188×n_{div})-bytes. This is because the access start position would start midway through the sector #N+1, which is not permitted by the specifications according to the existing file system rules. Therefore, it is necessary to perform an alignment adjustment in order to meet both the 188 byte TS packet boundary and the 2048-byte sector boundary.

As a method of performing the above-mentioned alignment adjustment of the TS packet boundary and the sector boundary, it is effective to record a TS packet (a NULL packet) constituted only of dummy information having neither image nor audio data, onto the disk.

The NULL packet. is specified in the MPEG standard. That is, the MPEG standard specifies that when the data from the MPEG-2 TS stream compressed on the sending side is expanded on the receiving side, a data expansion process itself is not performed when NULL packet data is transmitted.

Description is now made of the alignment adjusting method for the data after the divide position at 188×n_{div} bytes where the NULL packet was used. First, the following formula (1) is used to calculate an offset value L from the divide position up to the next consecutive sector #N+1 (step 3 of FIG. 7, FIG. 4A).

L=2048−((188×n_{div})mod2048) (1)

Note that the operator “mod”, as in “A mod B”, indicates a remainder after “A” is divided by “B”.

Next, based on the offset value L calculated using the formula (1), the following formula (2) is used to calculate a number n_{NULL} of NULL packets which must be added in order to align the TS packet boundary at 188 bytes and the sector boundary at 2048 bytes (step 4 of FIG. 7, FIG. 4B).

n_{NULL} meets: (L+188×n_{NULL})mod2048=0 (2).

In order to actually write onto the disk the n_{NULL} quantity of NULL packets obtained using the formula (2), the disk is searched for unrecorded sector areas #X, and 188×n_{NULL}-bytes of NULL packets are recorded from sector number #X (step 5 of FIG. 7, FIG. 4C).

Next, the following formula (3) is used to calculate the sector number #N_{DIV} containing the MPEG2 TS data divide position 188×n_{DIV} to be an objective (step 6 of FIG. 7, FIG. 5A).

#N_{DIV}=#N+(188×n_{DIV})/2048 (3)

One sector (assumed as 2048 bytes) from sector position #N_{DIV} obtained by the formula (3) is read into a buffer such as a random access memory, and dummy TS packet information is replaced by 2048-L bytes of data from the read start position in memory (step 7 of FIG. 7, FIG. 5B).

Further, the following formula (4) is used to calculate a sector number #Xend, which is where the last of 188×n_{NULL} bytes was recorded starting from the sector #X, which is where the dummy TS packets started being recorded on the disk (step 8 of FIG. 7, FIG. 6A).

#Xend =#X+(188×n_{NULL})/2048 (4)

Further, on the sector #Xend, 1 sector (2048-bytes) of the sector data that was read into the memory at step 7 is overwritten (step 9 of FIG. 7, FIG. 6B).

After performing the above-mentioned process, the following file information regarding FILE0002, which is the data after the divide position, is newly registered into the file system:

File name: FILE0002

First access start sector: #X

First access data size: 188×n_{NULL}+L bytes

Second access start sector: #N_{DIV}+1

Second access data size: 188'n₁−(188×n_{div}−L) bytes (step 10 of FIG. 7, FIG. 6C).

The above-mentioned process ends the dividing process for the MPEG-2 TS data recorded on the disk.

Description is made below of an example of a data combining process. FIG. 8 is a flowchart showing the procedure of the data combining process. FIGS. 9 through 14 show transport data recorded on the disk recording medium, and changes in the data structure on the disk due to the combining process. Note that the step numbers of FIG. 8 and the step numbers of FIGS. 9 through 14 correspond to each other.

First, as shown in FIG. 9, on the disk recording medium are the MPEG-2 TS file FILE0001 (access start sector N, with data size of 188×n1), and FILE0002 (access start sector K, with data size of 188×n2), and a process request to combine these data files has occurred (S701 of FIG. 8). Note that, in FIG. 9, the file system information before combining (file name, start sector number, data size) is also shown.

Hereinafter, description is made of the editing process when combining the 2 data files to make a new data file FILE0003. This process is, for example, performed by an application in the disk recording and reproducing device, in response to a request from the host computer or the like. In the description below, #N, #Nend, n1 and n2 are all integers equal to or greater than 0.

When the process request occurs, the application uses the following formula (5) to calculate an offset value L, from sector #N which is the data end of the data file FILE0001 on the disk recording medium, to a sector consecutively following a position 188×n1 bytes from the sector #N (S702).

L=2048−((188×n1)mod2048) (5)

Further, the following formula (6) is used to calculate the sector number #Nend, which contains the data end of FILE0001, as shown in FIG. 10B.

#Nend=#N+(188×n1)/2048 (2)

Next, as shown in FIG. 11, 2048-L bytes of sector data of sector #Nend from formula (6) are read into the buffer such as a random access memory (not shown), and a process is performed to add L-bytes of dummy TS packet data from the sector data end position that was read (S704).

Next, as shown in FIG. 12A, the 2048-byte sector data in which the dummy TS packet information is added is overwritten on the sector #Nend (S705). As shown in FIG. 12B, the access start sector #N, the access size of 188×n1+L are renewed in the information concerning the FILE0003 that is produced in the file system after combining. The information of file FILE0003 may be renewed in the memory, or may be written onto the disk.

Next, the following formula (7) is used to calculate a data size M of dummy TS packet data overflowing beyond the 188-byte TS packet unit, when L bytes of the dummy TS packet data is added at S704, as shown in FIG. 12C (S707). In other words, one sector is 2048 bytes and the dummy TS packet data is a 188-byte unit, so that the portion left over from the 188-byte dummy TS packet data at the sector end as shown in FIG. 12A is calculated as a remainder M.

M=188−(Lmod188) (7)

Further, as shown in FIG. 13A, the value M is used in the following formula (8), to calculate a number n_{NULL} of dummy TS packets which must be added for the alignment adjustment of the sector boundary and the TS packet boundary (S708).

n_{NULL} meets: (M+188×n_{NULL})mod2048=0 (8)

Next, after searching for the unrecorded sector area (start sector number #X) on the disk recording medium as shown in FIG. 13B, the dummy data M overflowing from the TS packet boundary calculated by the formula (7), and the dummy TS packets n_{NULL} calculated by the formula (8) is written (S709).

Further, as shown in FIG. 13C, in the file system information pertaining to the FILE0003, the start sector number #X and the data size 188×n_{NULL}+M bytes of information are added/renewed (S710).

Finally, as shown in FIG. 14, the file system information from the original FILE0002, its start sector number #K and its access data size of 188×n2 bytes are registered into the file system information of FILE0003, and thus the combining process ends (S711). As a result of the above-mentioned process, the FILE0003 is recognized as a combination of 188×n1+L bytes of data from the sector #N, sector #X, and data of data size of 188×n_{NULL}+M bytes, and data of 188×n2 bytes from sector #K.

When the above-mentioned process is performed, the combining process for the MPEG-2 TS data recorded on the disk ends.

However, in the case where the user performs the above-mentioned dividing/combining editing process on the MPEG-2 data file recorded on the disk, it is necessary to perform the alignment adjustment using a data structure that meets both the 188-byte TS packet boundary serving as the MPEG-2 TS data unit, and the sector boundary for recognizing the edited data as a file in the file system.

In order to achieve this, it is necessary to perform many stages of process to make large-scale updates to file system information such as the position and size regarding the data recorded on the disk. This places a large burden on the CPU (Central Processing Unit) governing all the processes of the recording/reproducing and editing device.

Further, when reproducing the MPEG-2 TS data file newly created by the above-mentioned editing process, if the sector position where the NULL packet data was recorded, and the sector position where the TS packet data having the actual image and audio signals is recorded, are physically very separated on the disk, this increases the number of times to perform a head seek and seek distances up to a desired reproduction access start position, and there was a possibility that seamless reproduction could not be achieved.

### SUMMARY OF THE INVENTION

The present invention has been made in view of the above-mentioned problems, and therefore has as an object to provide a data editing method capable of alleviating a processing load on a CPU without increasing head seek times.

According to the present invention, there is provided a data editing method for editing MPEG-2 transport stream data recorded on a disk form recording medium having a plurality of sectors, the data editing method including:

detecting a common boundary position which is located before one of a divide position and a combine position in data designated, and meets a packet boundary and a sector boundary; and

performing one of a dividing process and a combining process for the data at the common boundary position as a reference.

### BRIEF DESCRIPTION OF THE DRAWINGS

FIG. 1 is a diagram showing MPEG-2 TS data recorded on a disk form recording medium according to a conventional example;

FIG. 2 is a diagram showing file system information of the MPEG-2 TS data of FIG. 1;

FIGS. 3A and 3B are diagrams for explaining a data dividing process of FIG. 1;

FIGS. 4A, 4B and 4C are diagrams for explaining the data dividing process of FIG. 1;

FIGS. 5A and 5B are diagrams for explaining the data dividing process of FIG. 1;

FIGS. 6A, 6B and 6C are diagrams for explaining the data dividing process of FIG. 1;

FIG. 7 is a flowchart showing a conventional data dividing process;

FIG. 8 is a flowchart showing a combining process for the MPEG-2 TS data according to the conventional example;

FIG. 9 is a diagram for explaining the combining process of FIG. 8;

FIGS. 10A and 10B are diagrams for explaining the combining process of FIG. 8;

FIG. 11 is a diagram for explaining the combining process of FIG. 8;

FIGS. 12A, 12B and 12C are diagrams for explaining the combining process of FIG. 8;

FIGS. 13A, 13B and 13C are diagrams for explaining the combining process of FIG. 8;

FIG. 14 is a diagram for explaining the combining process of FIG. 8;

FIG. 15A is a diagram showing a data structure, and FIG. 15B is a diagram showing file information of the MPEG-2 TS data before the dividing process according to the present invention;

FIG. 16A is a diagram showing a data structure, and FIG. 16B is a diagram showing file information of the MPEG-2 TS data after the dividing process according to the present invention;

FIG. 17 is a flowchart showing a flow of a dividing process for the MPEG-2 TS data according to the present invention;

FIG. 18 is a block diagram showing an embodiment of the present invention;

FIG. 19 is a flowchart showing a data combining process according to an embodiment of the present invention;

FIG. 20 is a diagram for explaining the combining process of FIG. 19;

FIGS. 21A and 21B are diagrams for explaining the combining process of FIG. 19; and

FIGS. 22A and 22B are diagrams for explaining the combining process of FIG. 19.

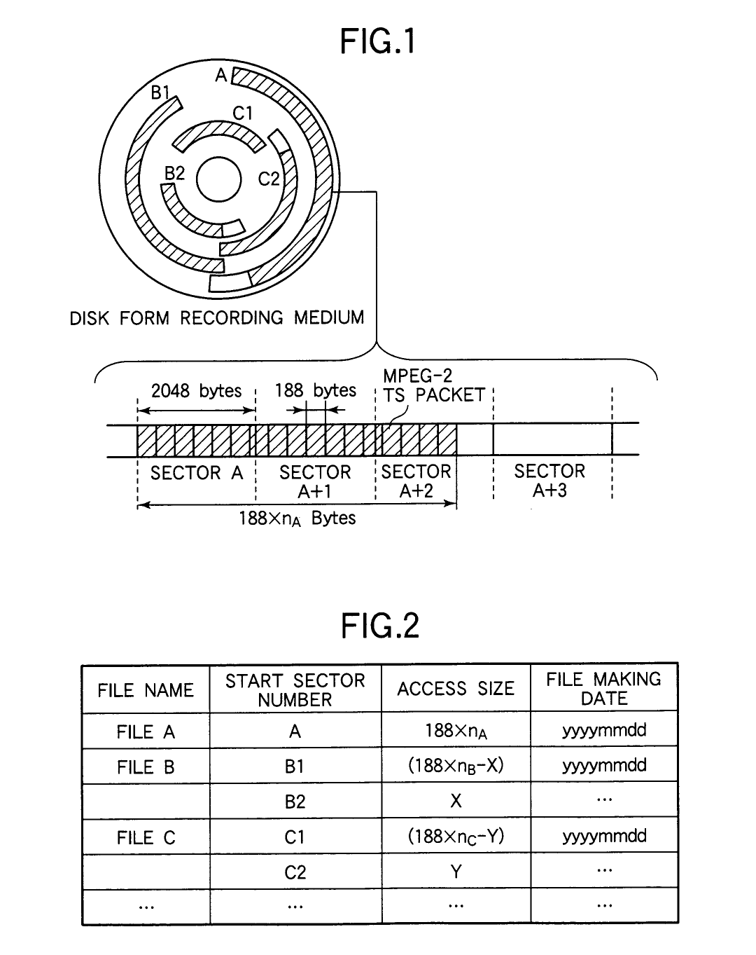

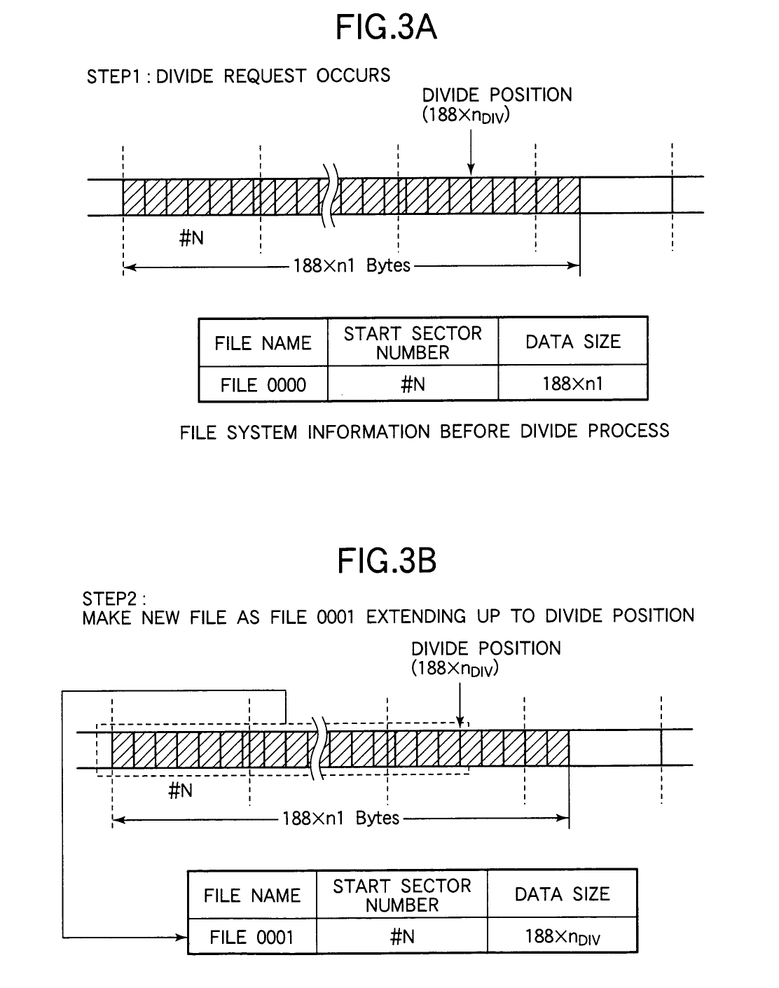

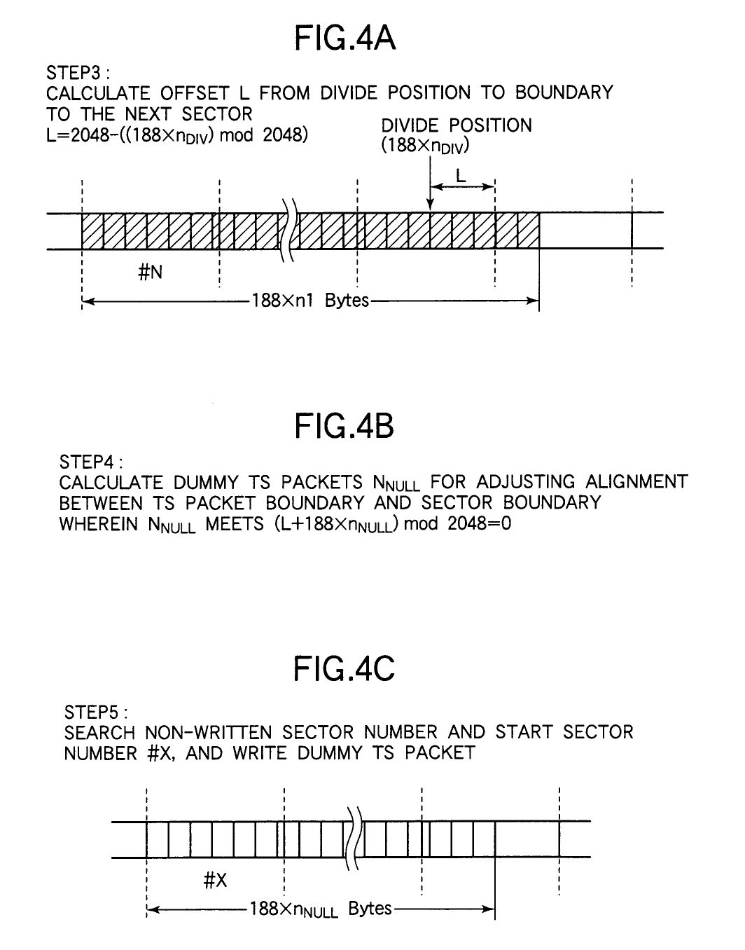

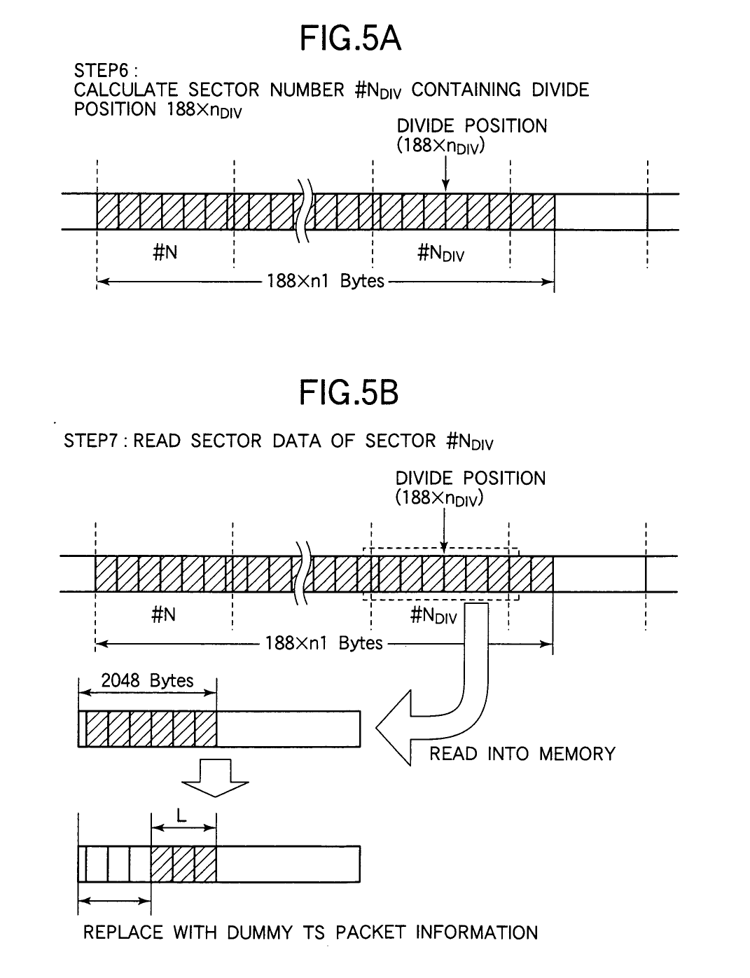

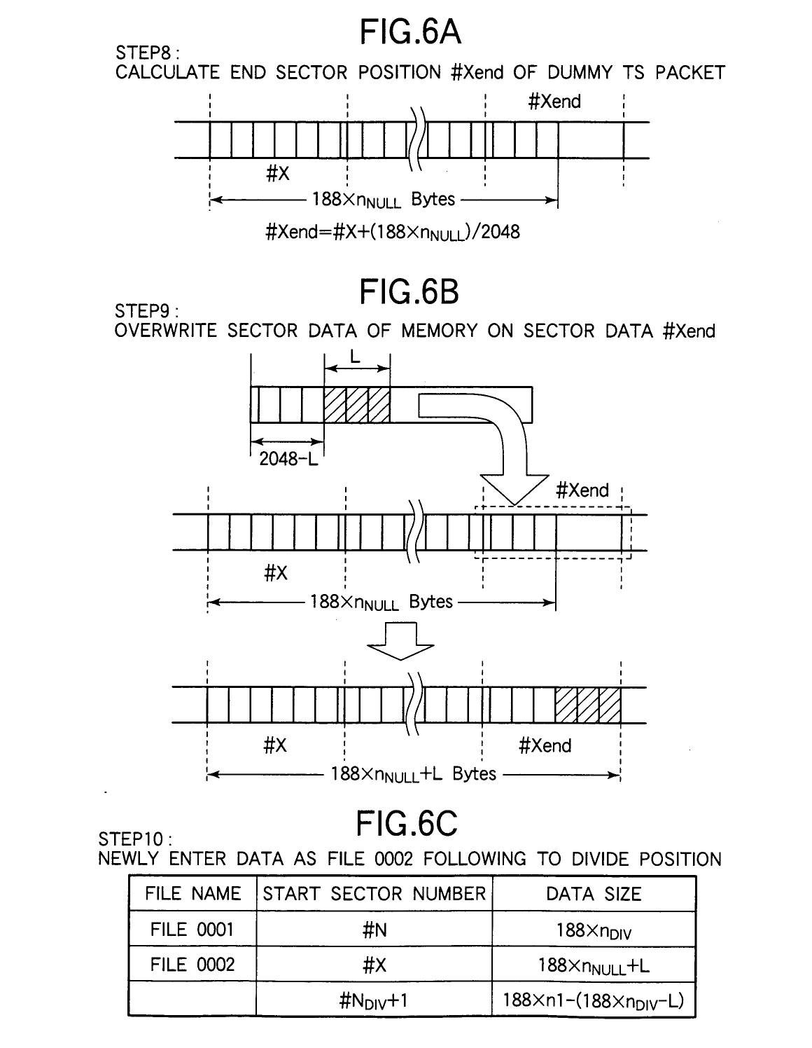

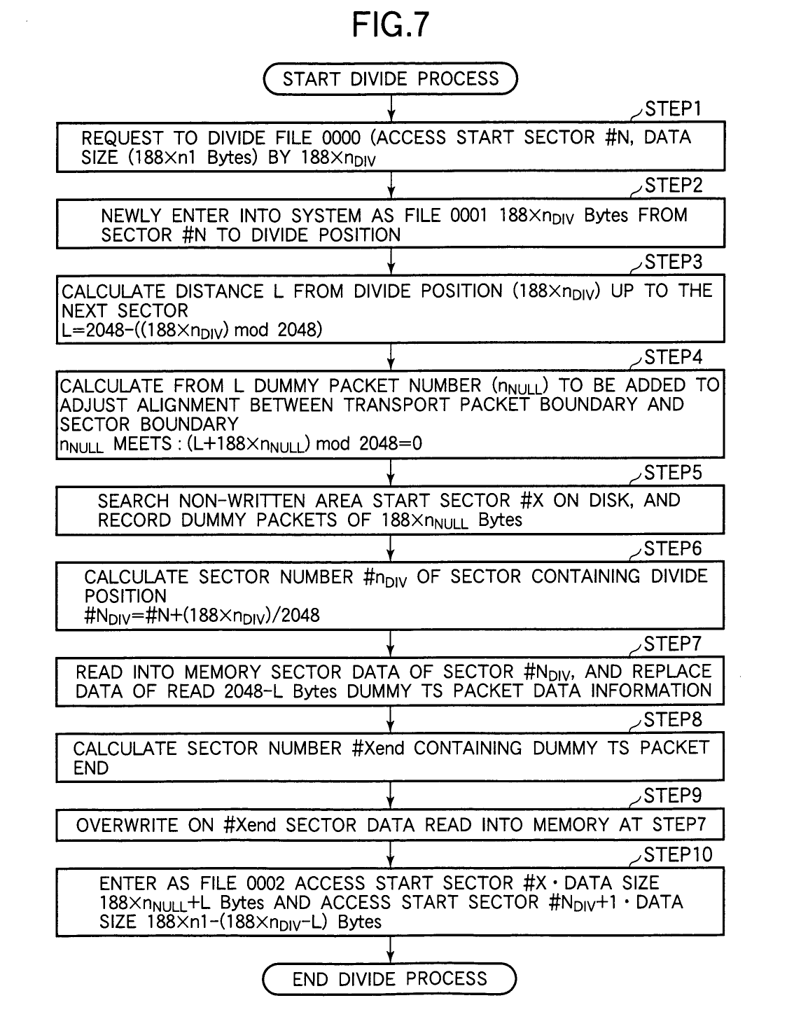

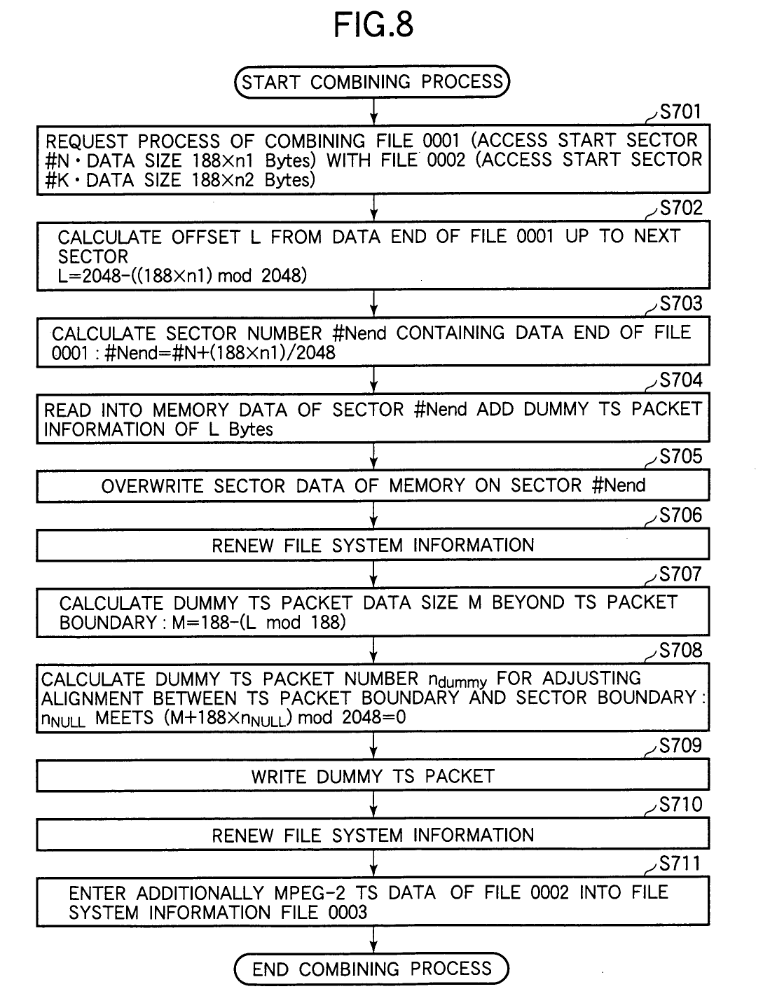

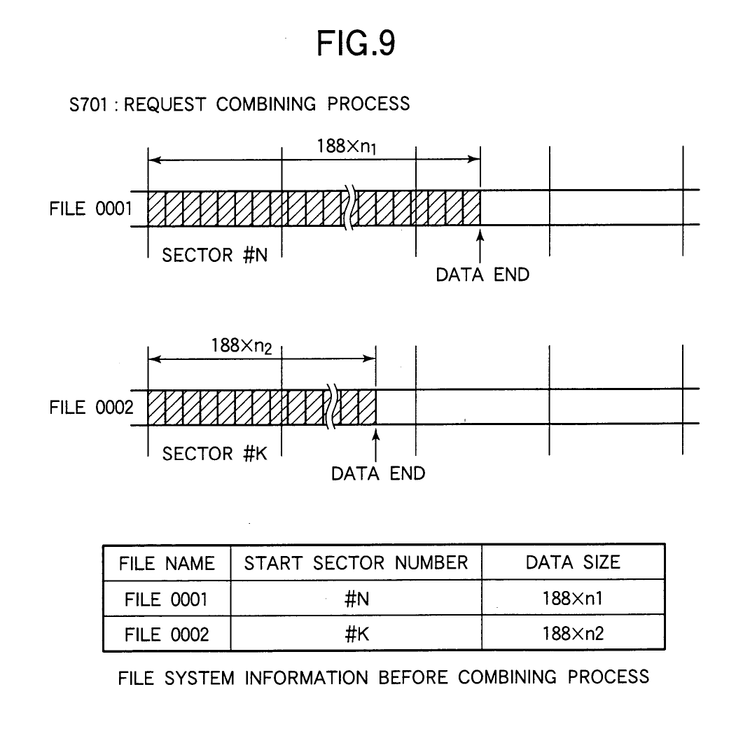

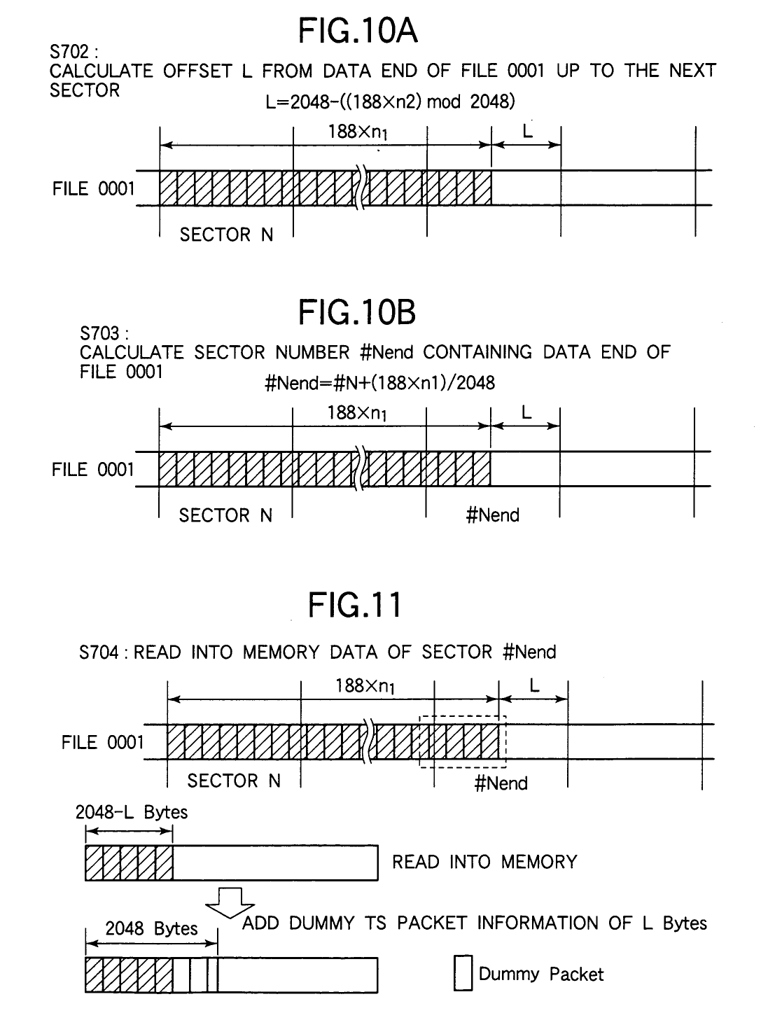

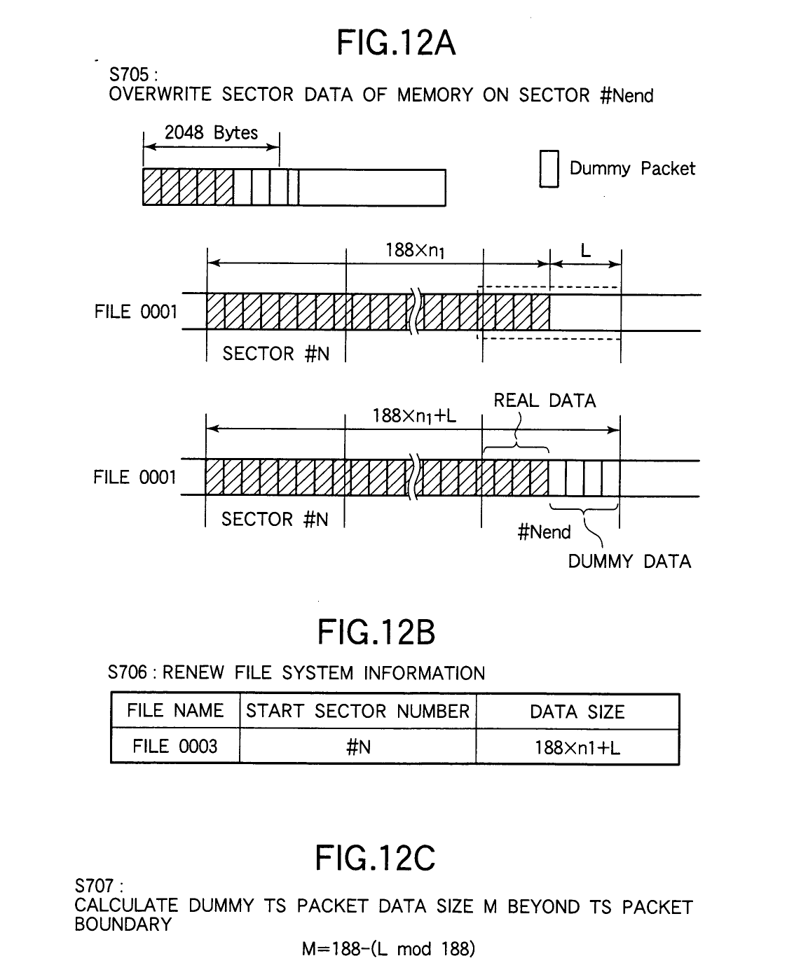

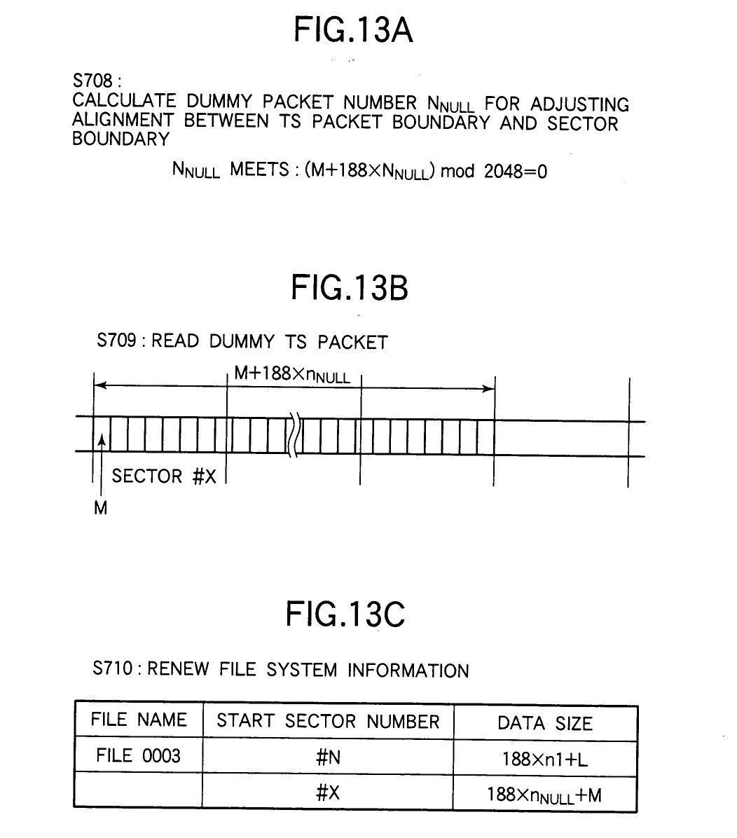

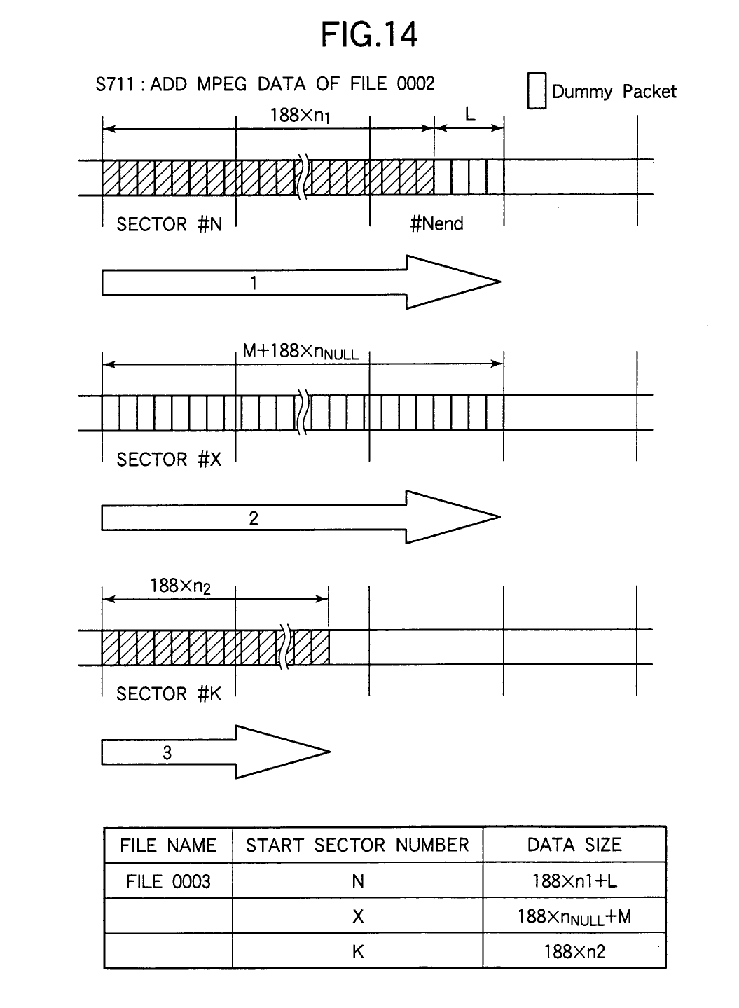

### DESCRIPTION OF THE PREFERRED EMBODIMENTS

Embodiment 1

Next, embodiments of the present invention are described in detail with reference to the drawings. First, in a method of dividing/editing an MPEG-2 TS data file according to Embodiment 1, a dividing process is performed at a common boundary position as a reference, which meets both a sector boundary before a position where a user requested (designated) the dividing process concerning MPEG-2 TS data recorded on a disk and a 188-byte packet boundary. An area from the above-mentioned designated position to the common boundary position (a maximum of 94 Kbytes can be edited each time) is forcibly overwritten with a TS packet that is constituted of dummy information on which data decoding expansion is not performed, by a decoding device for decoding private data, NULL data, or other such transport stream. Note that, NULL packet data is used as a dummy TS packet data format.

By performing the above-mentioned process, it is not necessary to write a new data record onto an unrecorded area on the disk to align the sector boundary and the TS packet boundary.

The area from the object data start position to the common boundary position is registered as a single MPEG-2 TS data file produced after the dividing process. The area from the common boundary position to the end of object MPEG-2 TS data is registered as another MPEG-2 TS data file. Simply renewing file system information is sufficient. Therefore, it is not necessary to go through many stages of process and greatly renew the file system information.

The above-mentioned embodiment enables convenient dividing process for the MPEG-2 TS data file recorded on a disk form recording medium having an existing file system.

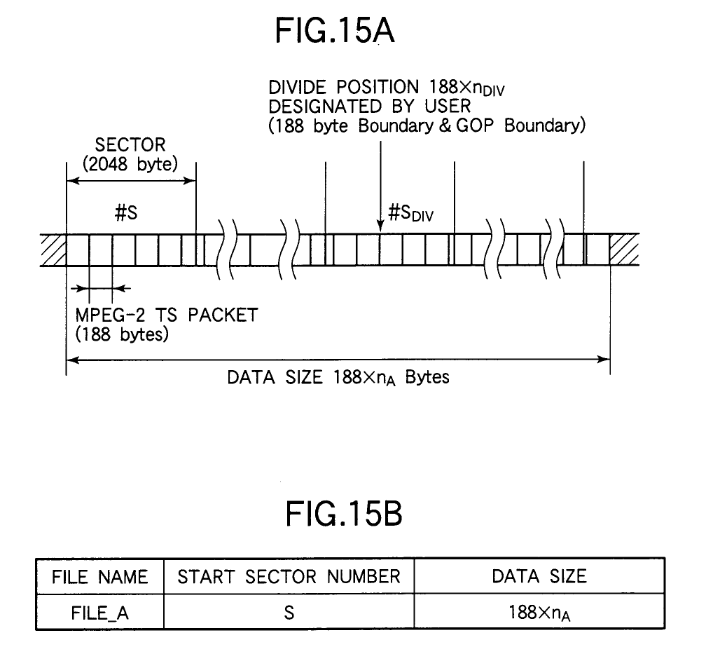

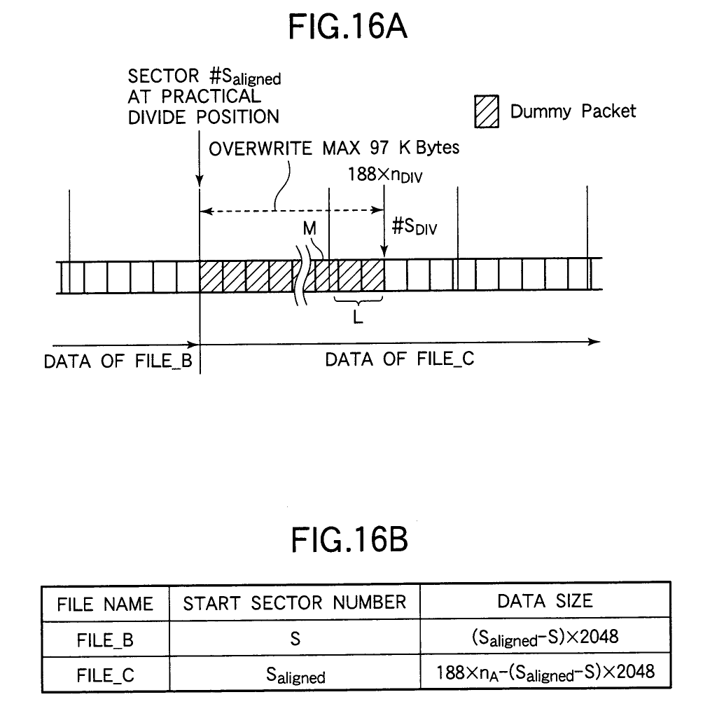

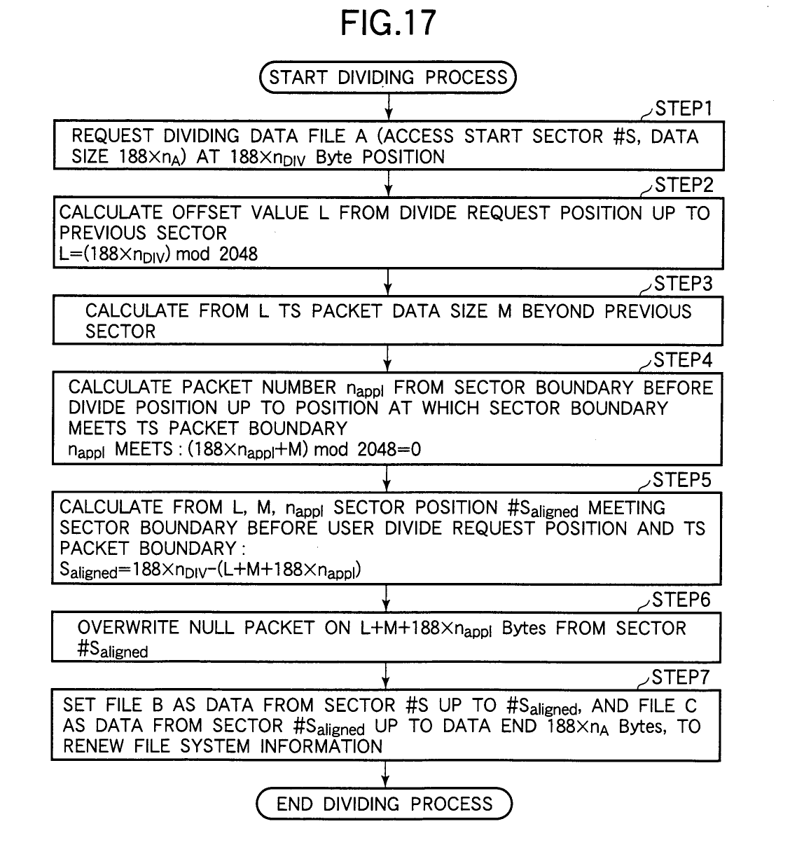

FIG. 15A shows a data structure of the MPEG-2 TS recorded on the disk before the dividing process. FIG. 15B shows file system information of the MPEG-2 TS data of FIG. 15A. FIG. 16A shows a data structure on the disk after the dividing process for the MPEG-2 TS file according to this embodiment. FIG. 16B shows file system information after the dividing process for the MPEG-2 TS data of FIG. 16A. Further, FIG. 17 is a flowchart showing the dividing process for the MPEG-2 TS data file according to this embodiment. Hereinafter, description is made of a data dividing process method according to this embodiment, with reference to FIGS. 15A through 17.

Note that a hardware structure in this embodiment is, for example, an optical disk device for recording/reproducing information on an optical disk, being connected to a personal computer. In response to a request from an application in the personal computer, the optical disk device performs the data dividing process, which is described below.

According to this embodiment, as shown in FIG. 15A, regarding a MPEG-2 TS data file FILE_A having a data size of 188×n_{A} bytes recorded on the disk starting at a sector #S, a user requests to divide the MPEG-2 TS file at a position 188×n_{div}, which is a packet boundary of the 188-byte TS packet, and make two files. One is a FILE_B having the data from the data position head to the divide position 188×n_{div}. Another is a FILE_C having. the data from the divide position to the end of the data file. Description is now made of the dividing process in the case where the above-mentioned request occurs.

When the above-mentioned request occurs (step 1 in FIG. 17), first, the following formula (9) is used to calculate an offset value L from the divide position 188×n_{div} requested by the user (application) up to the boundary between a sector #S_{DIV}−1 located forward (i.e., in the direction opposite the reproduction direction) from the divide position (step 2).

L=(188×n_{div})mod2048 (9)

Next, from the offset value L, the following formula (10) is used to calculate the TS packet data size M extending beyond the area from the sector #S_{DIV} to the sector #S_{DIV}−1 (step 3).

M=188−(Lmod188) (10)

Next, based on M which was obtained using the formula (10), the following formula (11) is used to calculate a number nₐₚₚₗ of TS packets existing from the sector boundary before the sector #S_{DIV} up to the position at which the sector boundary meets the TS packet boundary (step 4).

nₐₚₚₗ meets: (188×nₐₚₚₗ+M)mod2048=0 (11)

Further, when the number of packets is obtained, the following formula (12) is used to calculate a sector position #S_{aligned} which meets the alignment of both the sector boundary before the divide position 188×n_{div} bytes requested by the user and the TS packet boundary (step 5).

S_{aligned}=188×n_{div}−(L+M188×nₐₚₚₗ) (12)

Based on the value obtained above, the MPEG-2 TS data file FILA_A recorded on the disk is overwritten with (L+M+188×nₐₚₚₗ)-bytes of TS packet data as NULL packets, actually on the disk, starting from the sector #S_{aligned}, as shown in FIG. 16A (step 6).

When the above-mentioned process for overwriting the NULL packets is completed, as shown in FIG. 16B, the MPEG-2 TS data having the data size from the access start sector #S of the MPEG-2 TS data FILE_A before division up to the sector #S_{aligned} where the NULL packet overwriting is started, is set as FILE_B. The MPEG-2 TS data starting access from #S_{aligned} and having a data size up to the end of the data of FILA_A is set as FILE_C. These files FILE B and FILE_C are registered into the file system information (step 7.).

By performing the above-mentioned process, the dividing process that is performed on the MPEG-2 TS data file recorded on the disk according to this embodiment is completed.

Note that each time the dividing/editing process is performed on one of the MPEG-2 TS data, the data size to overwrite by the NULL packet is at most 94 Kbytes, which is the least common multiple of 2048 and 188. However, the MPEG-2 TS data transfer rate used in digital broadcasting is 25 Mbits per second, which is extremely fast. Therefore, it takes only approximately 0.0308 seconds, which is instantaneous for the user, to overwrite the data with the 94 Kbytes of NULL packets at most. Therefore, this level does not cause visual disturbance.

Embodiment 2

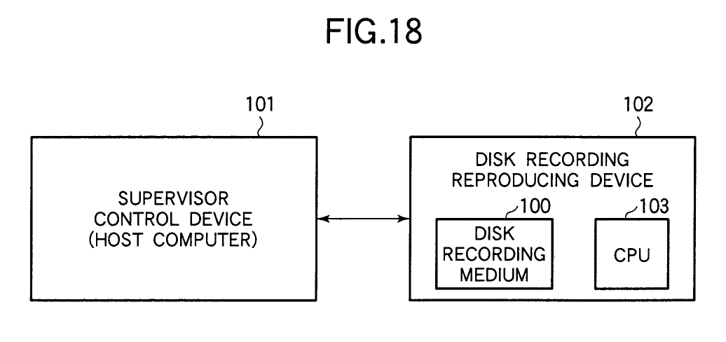

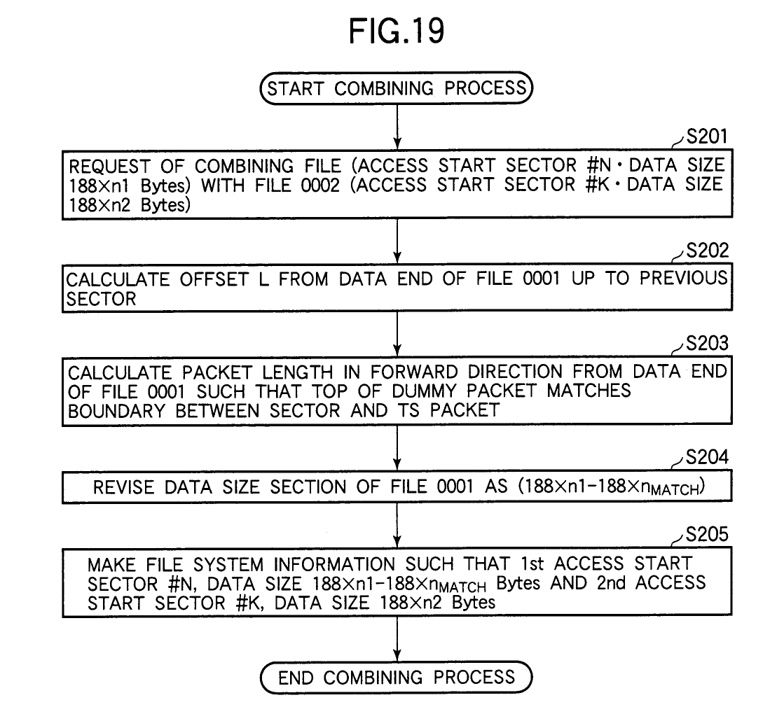

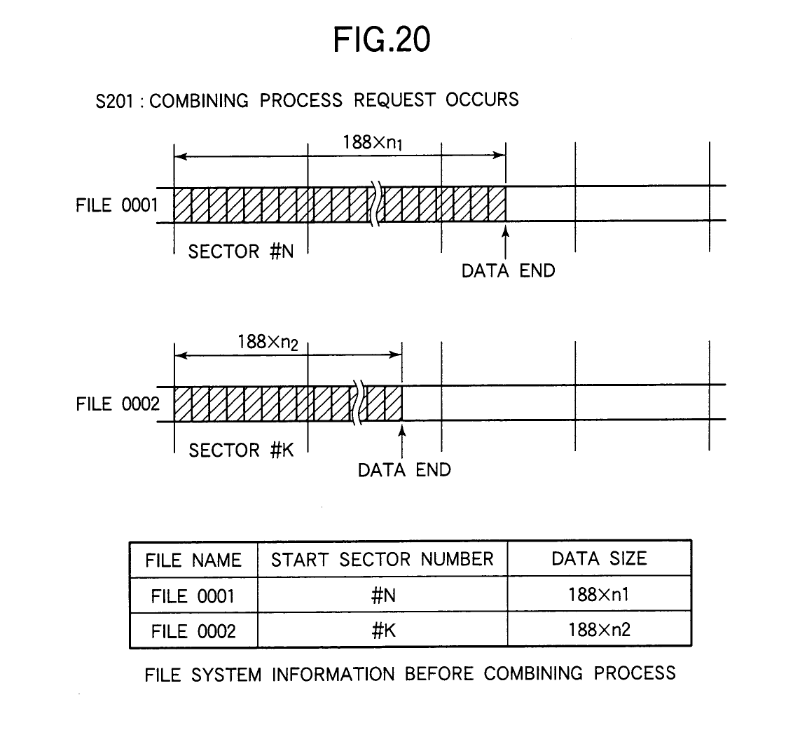

Next, detailed description is made of Embodiment 2 of the present invention with reference to the drawings. FIG. 18 is a block diagram showing an embodiment of the present invention. FIG. 19 is a flowchart showing a combining process for data according to this embodiment. FIGS. 20 through 22B are diagrams for explaining each process performed during the data combining process. Note that, the step numbers of FIG. 19 correspond with the step numbers of FIGS. 20 through 22B.

First, in this embodiment, as shown in FIG. 18, a superior control device 101 such as a host computer is connected to a disk recording and reproducing device 102. In response to a request from the superior control device 101, the disk recording and reproducing device 102 performs recording of the MPEG-2 TS transport stream data to a disk recording medium 100, or performs reproduction of the recorded data. As the disk recording medium 100, a hard disk, an optical disk, or the like may be used.

Further, in response to the request from the superior control device 101, the disk recording and reproducing device 102 performs an editing process such as the combining process on the file data. A CPU (Central Processing Unit) 103 is provided inside the disk recording and reproducing device 102. This CPU 103 performs control of each part of the device 102. In response to the request from the superior control device 101, the CPU 103 performs control to record/reproduce the data on the disk recording medium 100, or an editing processing such as a file data combining process. Since a construction of the disk recording and reproducing device 102 is commonly known, detailed description is omitted.

Note that the present invention is not limited to this construction. The present invention can also be used in a case where the data is recorded/reproduced, or combined/edited, or undergoes a like process merely by using the disk recording and reproducing device according to an instruction from the user.

Here, according to this embodiment, as shown in FIG. 20, two MPEG-2 TS files FILE0001 (access start sector number N, data size 188×n1) and FILE0002 (access start sector number K, data size 188×n2) are recorded on the disk recording medium. A process request to combine a FILE0002 after FILE0001 and make a new data file FILE0003, is issued from the superior control device 101 (S201 of FIG. 19).

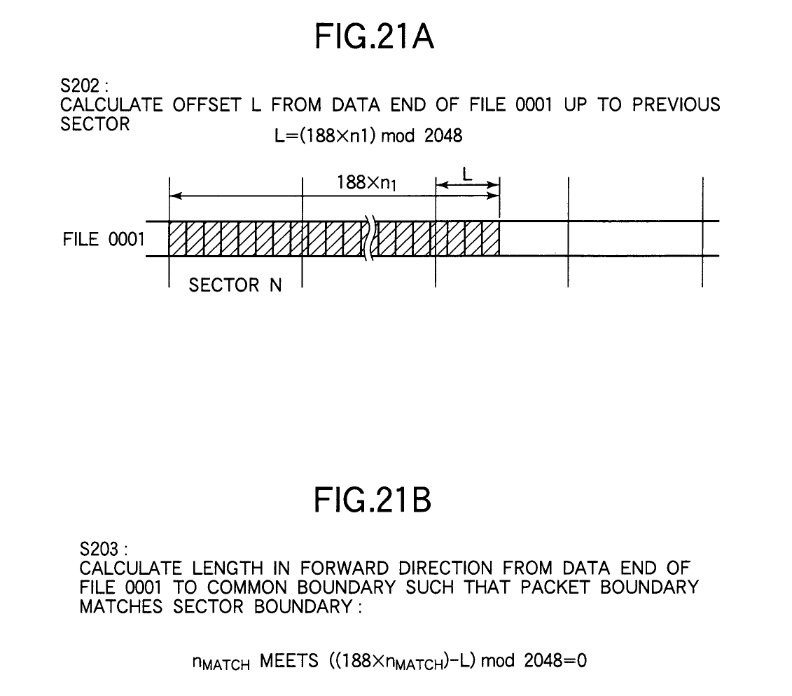

When this process request occurs, first, as shown in FIG. 21A, the disk recording and reproducing device 102 uses the following formula (13) to calculate the offset L from the FILE001 data end to the previous sector (S202). The size of one sector is, for example, 2048 bytes.

L=(188×n1)mod2048 (13)

Next, as shown in FIG. 21B, the following formula (14) is used to calculate a length in forward direction from the data end of the FILE0001 to the position where the TS packet boundary and the sector boundary meet (S203).

n_{MATCH} meets: (188×n_{MATCH}1−L)mod2048=0 (14)

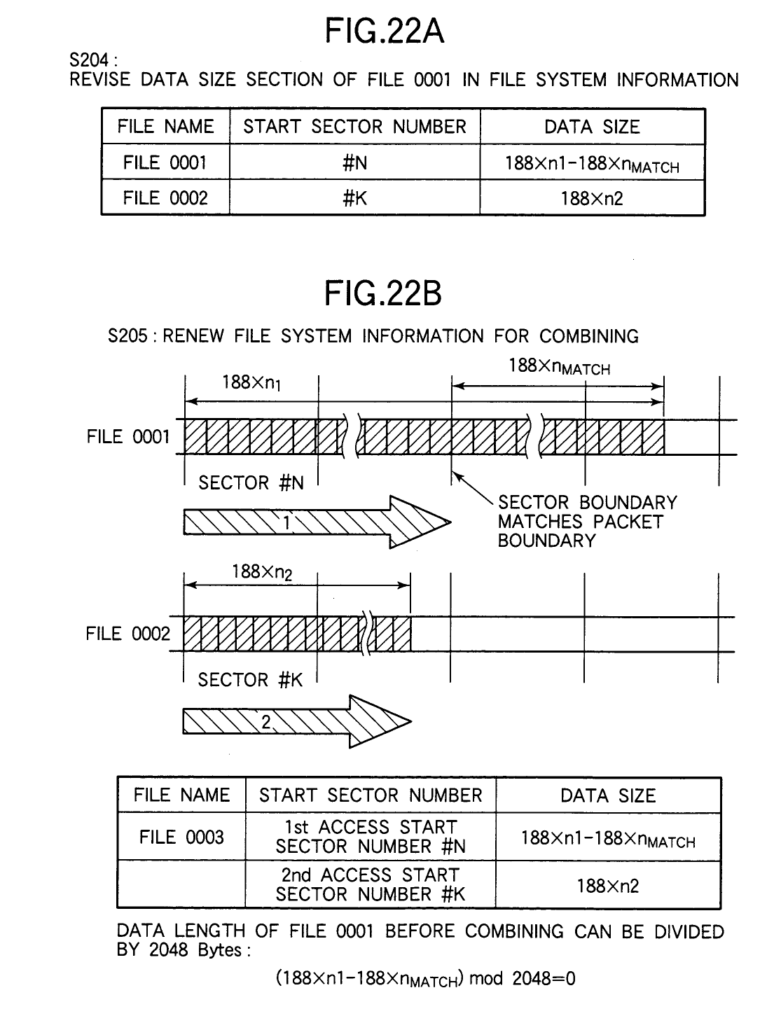

Further, as shown in FIG. 22A, based on n_{MATCH} which was obtained, the data size section of the FILE0001 in the file system information is revised to (188×n1−188×n_{MATCH}) and renewed (S204). The file system information of the original file FILE0001 remains.

Next, file system information of the file FILE0003 after combining is made (S205). Specifically, as shown in FIG. 22B, the start sector numbers of the file FILE0003 are: a first access start sector number #N having data size of (188×n1−188×n_{MATCH}); and a second access start sector number #K having a data size of (188×n2).

At this time, as shown in FIG. 22B, the position in front of the end of the file FILE0001 at (188×n_{MATCH}) is the common boundary position where the TS packet boundary and the sector boundary match each other, as described above. According to this embodiment, simply by making the file system information for the new file FILE0003 after combining, the file data combining process ends.

Here, when reproducing the file FILE0003, as shown in FIG. 22B, the data behind the common boundary position (the 188×n_{MATCH} portion) in the FILE0001 is not reproduced. The size of this portion is at most 94 Kbytes, which is the least common multiple of 2048 and 188. However, the MPEG-2 TS data transfer rate used in digital broadcasting is 25 Mbits per second, which is extremely fast. Therefore, the 94 Kbytes of portion at most takes only approximately 0.0308 seconds, which is instantaneous for the user. This level does not cause a visual disturbance, even through it is not reproduced.

What is claimed is:

1. A data editing method for editing MPEG-2 transport stream data recorded on a disk form recording medium having a plurality of sectors, the data editing method comprising:
detecting a common boundary position which is located before one of a divide position and a combine position in data designated, and meets a packet boundary and a sector boundary; and
performing one of a dividing process and a combining process for the data at the common boundary position as a reference.

2. A data editing method according to claim 1, wherein data between the designated divide position and the detected common boundary position is overwritten with dummy packet data.

3. A data editing method according to claim 2, wherein the dummy packet data is one of private data and NULL packet data where data expansion is not performed.

4. A data editing method according to claim 1, wherein:
one part of the data subjected to the dividing process is managed based on information showing a start position of the data, and information showing a data size from the start position to the common boundary position; and
the other part of the data subjected to the dividing process is managed based on information showing the common boundary position, and information showing a data size from the common boundary position to an end position of the data.

5. A data editing method according to claim 1, wherein the data subjected to the combining process is managed based on information showing a start position of one part of the data, and information showing a data size from the start position to the common boundary position and a data size from a start position of the other part of the data to an end position.

6. A data editing method according to claim 1,. wherein data between the designated combine position and the detected common boundary position is discarded.
